(19) United States
(12) Patent Application Publication
(10) Pub. No.: US 2010/0175262 A1
(43) Pub. Date: Jul. 15, 2010

(54) ELECTRIC SHAVER

(75) Inventors: Hiroshi SHIGETA, Fujiidera (JP); Shin HOSOKAWA, Hikone (JP); Hiroaki SHIMIZU, Hikone (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/644,557

(22) Filed: Dec. 22, 2009

(30) Foreign Application Priority Data
Jan. 15, 2009 (JP) 2009-006425

(51) Int. Cl. B26B 19/00; B26B 19/28

(52) U.S. Cl. 30/43; 30/45

(57) ABSTRACT

An electric shaver includes a grip unit capable of being held in one hand, a head unit supported above the grip unit, a blade section provided in the head unit and having an outer blade and an inner blade for shaving, and a connecting section provided at a top of the grip unit and protruded toward a rear face side of the grip unit. The head unit is provided on the connecting section. According to the electric shaver, the grip unit can be held firmly in one hand and the blade section can be pressed onto a skin firmly.

### BACKGROUND OF THE INVENTION

1. Field of the Invention

The present invention relates to an electric shaver in which a head unit having a blade section for shaving is provided above a rod-shaped grip unit.

2. Description of Related Art

FIG. 5 shows a conventional electric shaver disclosed in Japanese Patent Application Laid-Open No. 2006-42897 (Patent Document 1). “A” indicates its front face side and “B” indicates its rear face side. This kind of electric shavers includes a head unit 101 having a blade section 101a for shaving and a rod-shaped grip unit 102 capable of being held in one hand.

Conventionally, the head unit 101 is connected in an extension of a center axial line of the grip unit 102. In case of a configuration shown in FIG. 5 wherein an upper portion of the head unit 102 is curved so as to fit into a hand (a central axis J2 of the upper portion is tilted forward to a central axis J1 of a lower portion), the head unit 101 is connected in an extension of the central axis J2. It would be appear that this configuration is made in order to reduce a front-to-rear thickness of the electric shaver.

### SUMMARY OF THE INVENTION

Therefore, the electric shaver generally has an outline shape with less-rugged surface. As a result, the electric shaver is slippery when held in a hand and may tend to be dropped off when the grip unit 102 is held with a weak holding force. In addition, the blade section is pressed onto a skin on shaving. However, it is hard to press the blade section onto a skin firmly with the above conventional outline shape.

Therefore, it is an object of the present invention to provide an electric shaver whose grip unit can be held firmly in one hand and whose blade section can be pressed onto a skin firmly.

An aspect of the present invention provides an electric shaver that includes a grip unit capable of being held in one hand, a head unit supported above the grip unit, a blade section provided in the head unit and having an outer blade and an inner blade for shaving, and a connecting section provided at a top of the grip unit and protruded toward a rear face side of the grip unit. Here, the head unit is provided on the connecting section.

According to the aspect of the present invention, since the connecting section is provided at the top of the rod-shaped grip unit with protruding rearward (backward) from the grip unit, an index finger can be held by the connecting section located under the head unit when the grip unit is held in one hand. Therefore, even when the grip unit is held with a weak holding force, the electric shaver is not to be dropped off. In addition, since the grip unit can be gripped with supported from its rear side with the connecting section located under the head unit held by an index finger, the head unit can be pressed onto a skin firmly for deep shaving. Therefore, an easy-to-use electric shaver can be provided. Further, since the connecting section protrudes toward a rear face side, a total height from a lower end of the grip unit to an upper end of the head unit can be reduced even with the head unit having complicated mechanisms and thereby downsizing of the electric shaver can be brought.

It is preferable that the head unit is configured to swing in a front-to-rear direction or in a side-to-side direction to the grip unit and the head unit is configured to locate a front-most edge thereof, within entire range of motion thereof, at a rearward side from a front face of the grip unit.

According to this configuration, the head unit is configured to locate its front-most edge at the rearward side from a front face of the grip unit while the head unit is moved in any manners. The head unit doesn't protrude from the front face of the grip unit even when the head unit is swung most so as to face the blade section upward. Similarly, the head unit doesn't protrude from the front face of the grip unit even when the head unit is swung most so as to face the blade section forward. Therefore, when placing the electric shaver on a table or the like with its front face side down, the blade section doesn't contact with the table. As a result, futile deformation of the blade section can be prevented. Further, a thumb supports the front face side of the grip unit and other fingers support the rear face side of the grip unit when the grip unit is held in one hand. Since the head unit locates backward from the thumb within its entire range of motion, the blade section can be faced to an area on a skin to be shaved.

It is preferable that the head unit is configured to swing in a front-to-rear direction or in a side-to-side direction to the grip unit and a front-to-rear swing mechanism for swinging the head unit in the front-to-rear direction or a side-to-side swing mechanism for swinging the head unit in the side-to-side direction is provided in the connecting section.

According to this configuration, since the swing mechanism is provided in the connecting section protruded toward the rear face side of the grip unit, incrementation of the total height of the electric shaver due to implementation of the swing mechanism can be restricted as mush as possible.

It is preferable that the head unit is tilted forward to a central axis of the grip unit and an outer surface of the outer blade of the blade section is faced forward so as to be seen from a front side of the electric shaver.

According to this configuration, since the outer surface of the outer blade of the blade section (blade surface) is faced forward, the outer blade can be pressed onto a skin easily and thereby pressing force can be applied to the outer blade easily.

It is preferable that the electric shaver further includes a constructed portion provided at a base of the connecting section that is attached on the grip unit.

According to this configuration, since an index finger can be fit into the constructed portion when the grip unit is held in one hand, the grip unit can be supported stably and thereby the electric shaver is not to be dropped off.

Here, it is further preferable that an upper edge of the front face of the grip unit is extended upward from the constructed portion and a thumb hold portion having a bent-back shape is formed at the extended portion of the grip unit.

According to this configuration, since a thumb can be fit into the thumb hold portion when the grip unit is held in one hand, the grip unit can be supported more stably and thereby the electric shaver is not to be dropped off.

It is preferable that an upper plane of the grip unit is formed as a tilted plane tilted rearward to a plane perpendicular to a central axis of the grip unit and the connecting section is provided on the tilted plane so as to be protruded toward the rear face side of the grip unit and to be offset downward from an upper edge of a front face of the grip unit.

According to this configuration, since the upper plane of the grip unit is formed as the tilted plane tilted rearward and the connecting section is provided on the tilted plane, the total height of the electric shaver can be restricted to make it short.

### BRIEF DESCRIPTION OF THE DRAWINGS

FIG. 1 is a perspective view of an electric shaver according to an embodiment of the present invention;

FIG. 2 is a schematic side view of the electric shaver;

FIG. 3A is a schematic side view of the electric shaver when its head unit is located at a neutral position;

FIG. 3B is a schematic side view of the electric shaver when its head unit is located at a forward-most position;

FIG. 3C is a schematic side view of the electric shaver when its head unit is located at a rearward-most position;

FIG. 4A is a schematic side view of the electric shaver showing an installation position of its side-to-side swing mechanism;

FIG. 4B is a schematic side view of the electric shaver showing an installation position of its front-to-rear swing mechanism; and

FIG. 5 is a side view of a conventional electric shaver.

### DETAILED DESCRIPTION OF THE EMBODIMENT

Hereinafter, an electric shaver of an embodiment according to the present invention will be explained with reference to drawings. In each of the drawing, “A” indicates its front face side and “B” indicates its rear (back) face side.

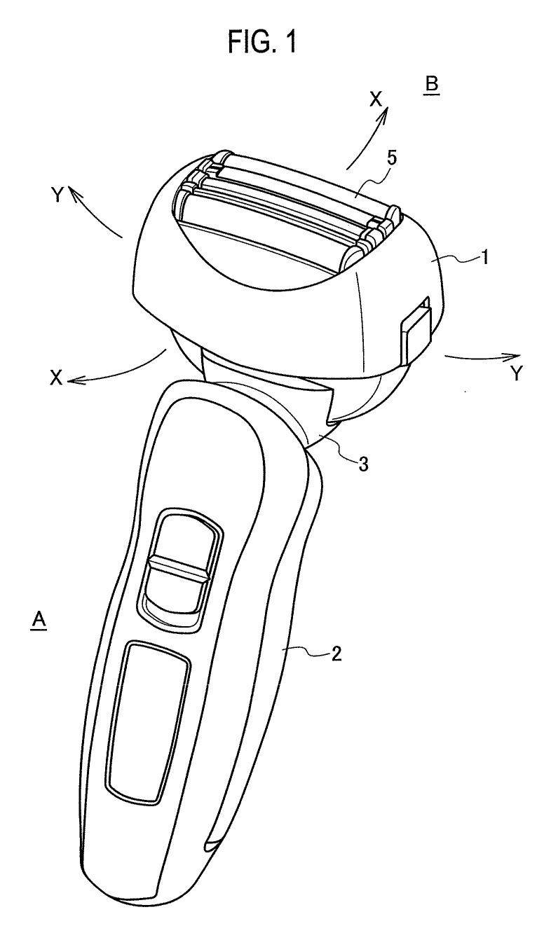

As shown in FIG. 1, the electric shaver of the present embodiment includes a rod-shaped grip unit 2 and a head unit 1. The grip unit 2 can be held in one hand. The head unit 1 is supported above the grip unit 2. The head unit 1 has a blade section 5 includes outer blades and inner blades (only the outer blades can be seen in FIG. 1). A connecting section 3 is provided at a top of the grip unit 2. The connecting section 3 protrudes to rearward of the grip unit 2. The head unit 1 is coupled with the connecting section 3.

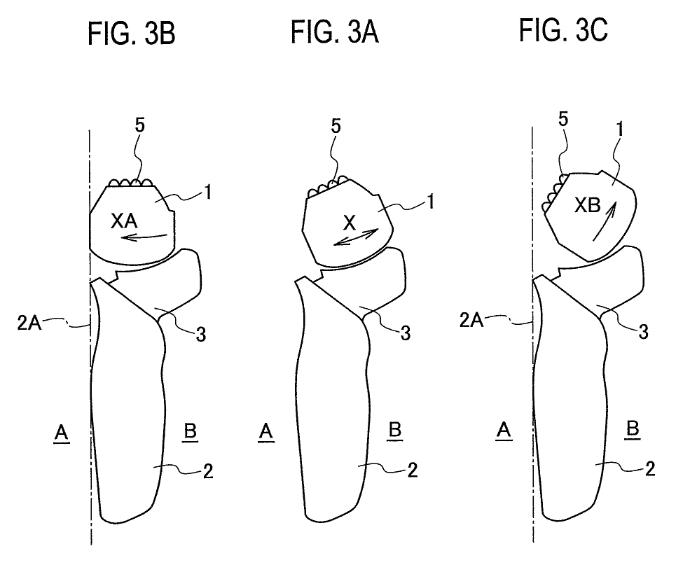

The head unit 1 can swing in a front-to-rear direction X and a side-to-side direction Y to the grip unit 2. As shown in FIGS. 3A to 3C, the head unit 1 is configured to locate its front-most edge, within its entire range of motion, at a rearward side from a front face 2A of the grip unit 2.

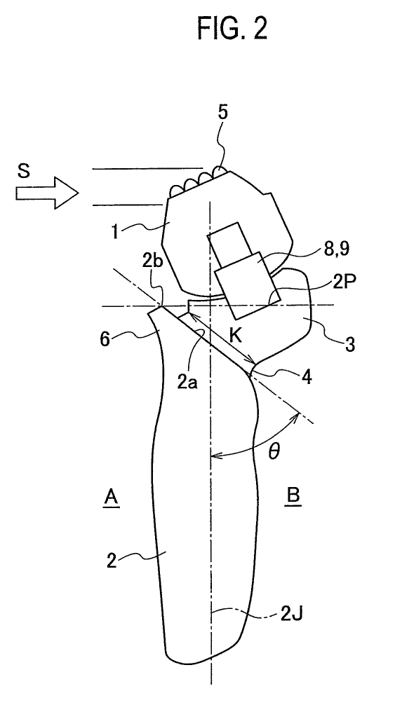

As shown in FIG. 2, the head unit 1 is in a state where the head unit 1 tilts forward to a central axis 2J of the grip unit 2 when the head unit 1 is located at its neutral position (central position in the front-to-rear direction). As a result, outer surfaces of the outer blades of the blade section 5 held in the head unit 1 are can be seen from the forward side (an allow S shown in FIG. 2 indicates a line of sight from the forward side).

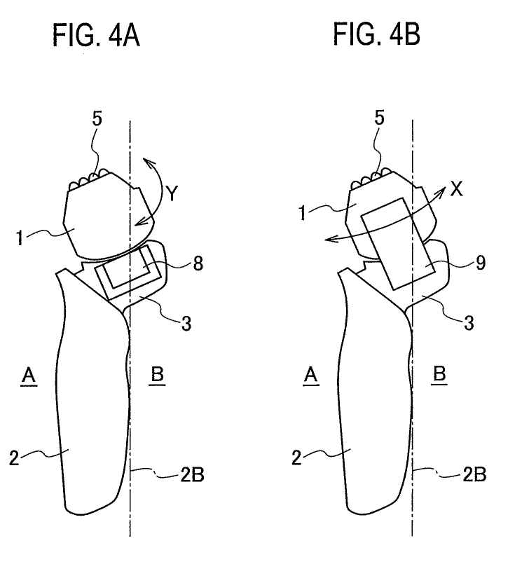

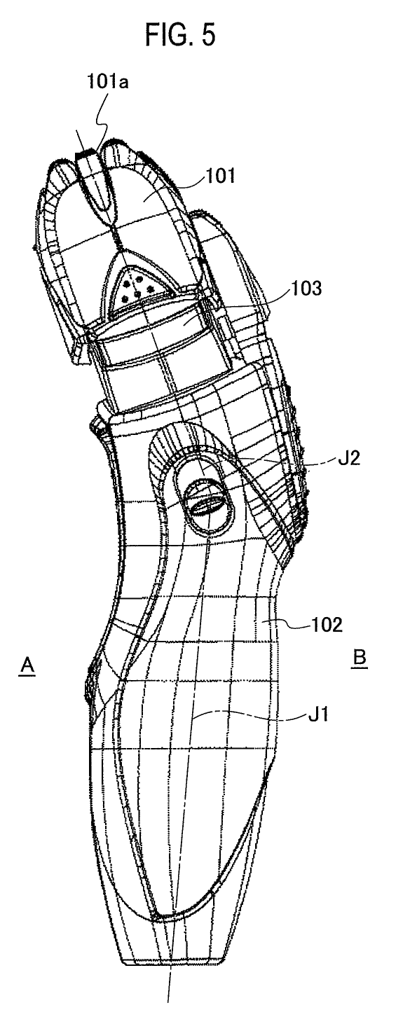

As shown in FIG. 4A, a side-to-side swing mechanism 8 for swinging the head unit 1 side to side is provided in the connecting section 3. As shown in FIG. 4B, a front-to-rear swing mechanism 9 for swinging the head unit 1 front to rear is also provided in the connecting section 3.

In addition, a constructed portion 4 is provided at a base of the connecting section 3 that is attached on the grip unit 2. A dimension K of the constructed portion 4 shown in FIG. 2 is made smaller than those of its vicinal portions. Further, an upper edge 2b of the front face 2A (see FIGS. 3A to 3C) is extended upward from the constructed portion 4. A thumb hold portion 6 having a bent-back shape is formed at the extended portion for receiving a thumb.

Furthermore, an upper plane 2a of the grip unit 2 is formed as a tilted plane tilted rearward to a plane 2P perpendicular to the central axis 2J of the grip unit 2. The connecting section 3 is attached on the tilted plane. Specifically, an angle θ between the upper plane 2a and the central axis 2J is not 90° but almost 45°. Therefore, the connecting section 3 protrudes rearward from the grip unit 2. In addition, the connecting section 3 is offset downward from the upper edge 2b of the front face 2A of the grip unit 2.

According to the present embodiment, since the connecting section 3 is provided at the top of the rod-shaped grip unit 2 with protruding rearward from the grip unit 2, an index finger can be held by the connecting section 3 located under the head unit 1 when the grip unit 2 is held in one hand. Therefore, even when the grip unit 2 is held with a weak holding force, the electric shaver is not to be dropped off. In addition, since the grip unit 2 can be gripped with supported from its rear side with the connecting section 3 located under the head unit 1 held by an index finger, the head unit 1 can be pressed onto a skin firmly for deep shaving. Therefore, an easy-to-use electric shaver can be provided. Further, since the connecting section 3 protrudes toward the rear face side B, a total height from a lower end of the grip unit 2 to an upper end of the head unit 1 can be reduced even with the head unit 1 having complicated mechanisms and thereby downsizing of the electric shaver can be brought.

In addition, according to the present embodiment, the head unit 1 is configured to locate its front-most edge at the rearward side from the front face 2A of the grip unit 2 while the head unit 1 is moved in any manners as shown in FIGS. 3A to 3C. The head unit 1 doesn't protrude from the front-most face 2A even when the head unit 1 is swung forward (in a direction indicated by an arrow XA) from its neutral position (FIG. 3A) to its forward-most position (FIG. 3B) so as to face the blade section 5 upward. Similarly, the head unit 1 doesn't protrude from the front-most face 2A even when the head unit 1 is swung rearward (in a direction indicated by an arrow XB) from its neutral position (FIG. 3A) to its rearward-most position (FIG. 3C) so as to face the blade section 5 forward. Therefore, when placing the electric shaver on a table or the like with its front face side A down, the blade section 5 doesn't contact with the table. As a result, futile deformation of the blade section 5 can be prevented. Further, a thumb supports the front face side A of the grip unit 2 and other fingers support the rear face side B of the grip unit 2 when the grip unit 2 is held in one hand. Since the head unit 1 locates backward from the thumb within its entire range of motion, the blade section 5 can be faced to an area on a skin to be shaved.

Since the side-to-side swing mechanism 8 and the front-to-rear swing mechanism 9 are provided in the connecting section 3 protruded toward the rear face side B of the grip unit 2, incrementation of the total height of the electric shaver due to implementation of the swing mechanisms 8 and 9 can be restricted as mush as possible. Since the outer surfaces of the outer blades of the blade section 5 (blade surfaces) are faced forward when the head unit 1 is at its neutral position, the outer blades can be pressed onto a skin easily and thereby pressing force can be applied to the outer blades easily.

Since the constructed portion 4 is provided at the base of the connecting section 3 and the thumb hold portion 6 having a bent-back shape is formed at the upper edge 2b of the front face 2A of the grip unit 2, an index finger can be fit into the constructed portion 4 and a thumb can be fit into the thumb hold portion 6 when the grip unit 2 is held in one hand. Therefore, the grip unit 2 can be supported stably and thereby the electric shaver is not to be dropped off.

Since the upper plane 2a of the grip unit 2 is formed as the tilted plane tilted rearward and the connecting section 3 is provided on the tilted plane, the total height of the electric shaver can be restricted to make it short.

What is claimed is:

1. An electric shaver comprising:
a grip unit capable of being held in one hand;
a head unit supported above the grip unit;
a blade section provided in the head unit and having an outer blade and an inner blade for shaving; and
a connecting section provided at a top of the grip unit and protruded toward a rear face side of the grip unit, wherein
the head unit is provided on the connecting section.

2. The electric shaver according to claim 1, wherein
the head unit is configured to swing in a front-to-rear direction or in a side-to-side direction to the grip unit, and
the head unit is configured to locate a front-most edge thereof, within entire range of motion thereof, at a rearward side from a front face of the grip unit.

3. The electric shaver according to claim 1, wherein
the head unit is configured to swing in a front-to-rear direction or in a side-to-side direction to the grip unit, and
a front-to-rear swing mechanism for swinging the head unit in the front-to-rear direction or a side-to-side swing mechanism for swinging the head unit in the side-to-side direction is provided in the connecting section.

4. The electric shaver according to claim 1, wherein
the head unit is tilted forward to a central axis of the grip unit, and
an outer surface of the outer blade of the blade section is faced forward so as to be seen from a front side of the electric shaver.

5. The electric shaver according to claim 1, further comprising
a constructed portion provided at a base of the connecting section that is attached on the grip unit.

6. The electric shaver according to claim 5, wherein
an upper edge of the front face of the grip unit is extended upward from the constructed portion, and
a thumb hold portion having a bent-back shape is formed at the extended portion of the grip unit.

7. The electric shaver according to claim 1, wherein
an upper plane of the grip unit is formed as a tilted plane tilted rearward to a plane perpendicular to a central axis of the grip unit, and
the connecting section is provided on the tilted plane so as to be protruded toward the rear face side of the grip unit and to be offset downward from an upper edge of a front face of the grip unit.
